(19) United States
(12) Patent Application Publication
(10) Pub. No.: US 2006/0101351 A1
(43) Pub. Date: May 11, 2006

(54) Event bookmarking

(75) Inventor: Adrian Cowham, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 10/981,654

(22) Filed: Nov. 5, 2004

(51) Int. Cl. G09G 5/36

(52) U.S. Cl. 715/783; 345/553

(57) ABSTRACT

A method for temporary visual indication of received items in a list and a corresponding system therefore are described. The method includes receiving an item to be presented in a list to be displayed to a user, applying a temporary visual indicator to the received item in the list; and removing the temporary visual indicator from each item in the list having a visual indicator applied, in response to user interaction with the list.

### FIELD OF THE INVENTION

The present invention relates to providing a temporary visual indicator to items in a list.

### BACKGROUND

It is known in the art to display items in a list to a user of a computer system using a user interface, e.g., using text lists or scrollable lists in windows displayed on a display. As items are added to the list, the list grows in length until, oftentimes, viewing of the list by the user requires scrolling the list. Prior systems providing a visual indicator of new items added to a list use a persistent indicator requiring user manipulation or interaction with the items of the list in order to remove the indicator from the items.

For example, many email application software provides a visual indicator of new messages, e.g., bolding of messages, in a list; however, the indicator is an attribute of the item in the list, i.e., the email message, and is changeable by the user. In the email example, new messages are indicated as unread, again typically by bolding of the message; however, a user may manipulate the email message attribute to indicate that a message has been read or unread. That is, after a user has read the message, i.e., by either opening the message or otherwise causing the contents of the message to be displayed to the user, thereby causing the bold indicator to be unbold and indicating the message has been read, the user may decide to change the indicator back to bold and indicate that the message has not been read, e.g., in order to remind the user of the message at a later time. The user manipulates the individual message attribute.

### SUMMARY

The present invention provides a method and system for applying a temporary visual indicator to received items in a list.

A method aspect includes applying a temporary visual indicator to received items in a list. Items are received which are to be presented in a list to be displayed to a user. A temporary visual indicator is applied to the received item in the list. The temporary visual indicator is removed from each item in the list having a visual indicator applied, in response to user interaction with the list.

Still other advantages of embodiments according to the present invention will become readily apparent to those skilled in the art from the following detailed description, wherein preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a network usable in conjunction with an embodiment of the present invention;

FIG. 2 is a user interface displaying items in a list;

FIG. 3 is the user interface of FIG. 2 displaying acknowledged and unacknowledged items in a list;

FIG. 4 is a high level process flow diagram according to an embodiment of the present invention;

FIG. 5 is the user interface of FIG. 2 displaying items in a list according to an embodiment of the present invention; and

FIG. 6 is a computer system useable in conjunction with an embodiment of the present invention.

### DETAILED DESCRIPTION

In contrast with the above-described approaches, the mechanism of the present invention provides a temporary visual indicator related to items in a list.

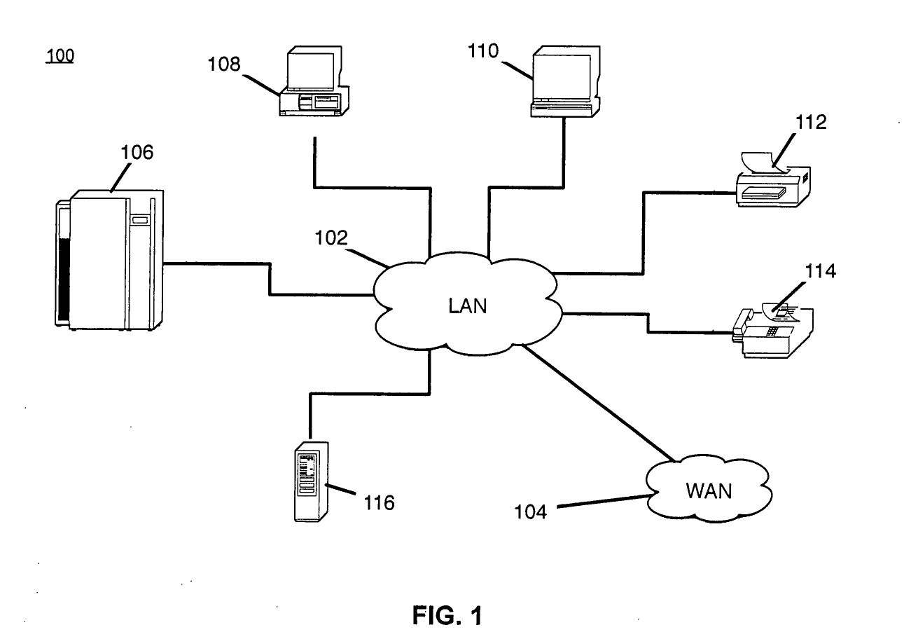

FIG. 1 depicts a plurality of devices connected via a local area network (LAN) 102. LAN 102 is further connected with a wide area network (WAN) 104. The plurality of devices includes a mainframe computer 106, a desktop computer system 108, a workstation 110, a printer 112, a facsimile device 114, and a server 116. The plurality of devices 106-116 and WAN 104 are representative in nature only and are not intended to restrict the scope of embodiments of the present invention. It is to be understood that devices and connections may be added or subtracted without altering the scope of the embodiments. For example, additional networked or networkable devices may be added, e.g., copiers, cameras, controllers, etc.

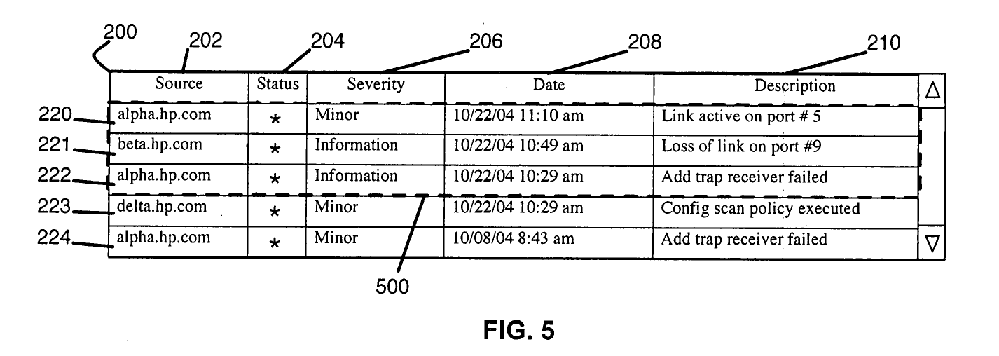

An embodiment of the present invention includes a sequence of instructions for execution by desktop computer system 108 such as the computer system depicted in FIG. 5 and described below. Alternate embodiments are contemplated in which the sequence of instructions are executed by alternate computer systems, e.g., mainframe computer 106, workstation 110, server 116, or other processing systems such as dedicated networkable devices. Further, it is understood that although the sequence of instructions may be executed by one networked device, e.g., server 116, a user may interact with the executing instructions via a different networked device, e.g., workstation 110. That is, a user interface may be presented to a user and interacted with by the user using a networked device different from the networked device executing the instructions.

The plurality of networked devices 106-116 transmit and receive messages to each other and to devices at other locations via LAN 102 and WAN 104. In particular, event messages reporting occurrence of an event at one of the networked devices 106-116 are transmitted via LAN 102 to one device, e.g., desktop computer system 108, whereby a user may be made aware of events at the networked devices without having to travel to each of the networked devices. Event occurrences include status reporting, error reporting, configuration change reporting and other types of events desired to be monitored by a user. For example, in one embodiment, a mainframe 106 may be configured to transmit a “heartbeat” or periodic event message to desktop computer system 108 in order to confirm proper operation of the mainframe. In another embodiment, network connectivity status, e.g., link status, may be reported by network connected devices such as switches, routers, and similar devices.

Depending on the size of the network, i.e., the number of reporting networked devices, and the threshold reporting level of both the networked devices and the user interface displayed to the user at desktop computer system 108, the number of event messages displayed to the user varies in number. In one embodiment, networked devices use the same message format, while in another embodiment the networked devices use one or more different event message formats. For example, the event message format includes simple network management protocol (SNMP) formats, Syslog message formats, and other event message formats. Additionally, in a further embodiment, specific custom or proprietary formats of a particular networked device are supported.

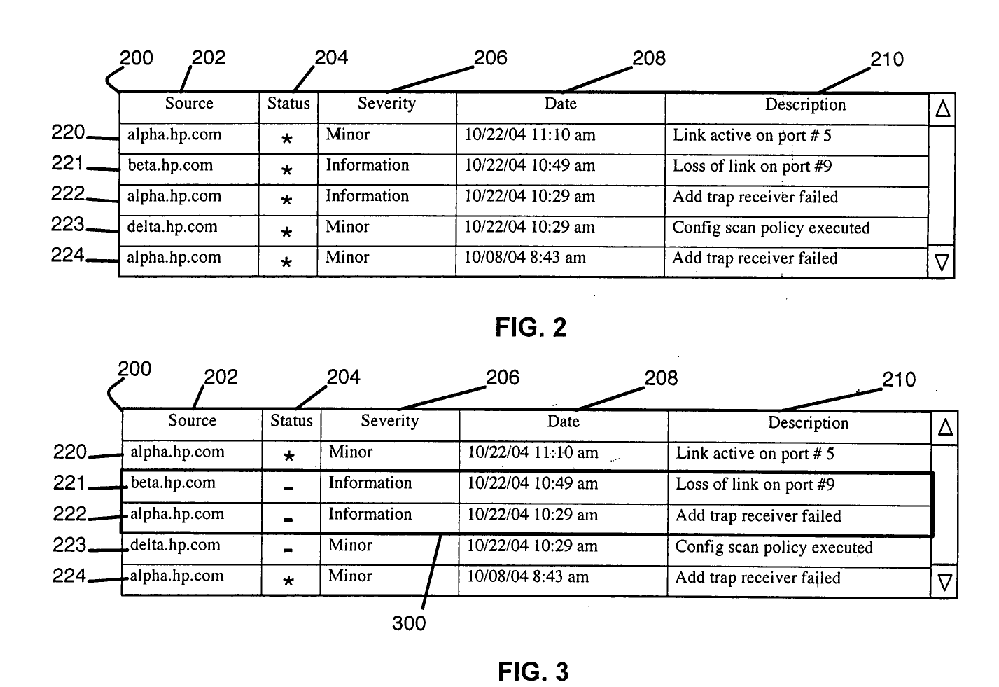

FIG. 2 depicts a user interface element 200, e.g., a scrollable list also referred to as an event list, for displaying via a display items in a list, e.g., a list of network events received by a computer system, to a user. User interface element 200 includes items presented in a row and column layout in a table format. The rows of the table include entry values for each item and according to the following column types: source 202, status 204, severity 206, date 208, and description 210. In alternate embodiments, additional column types may be added and existing column types subtracted depending on the particular information received in the event message and the information the user desires to be displayed. With respect to FIG. 2, each entry row of rows 220-224 corresponds to an event message received by desktop computer system 108. Further, rows 220-224 are arranged in chronological order with the most recently received event message displayed at the top of the list. As event messages are received, new row entries are added at the top of the list and older messages shift down the list.

In an alternate embodiment, a different user interface element type is used to display items, e.g., a text listing, a ticker-type scrollable listing, an iconic spacial arrangement, or other type element to display the items. That is, the scope of user interface element types useable includes more than a scrollable list type.

Source column 202 is an indicator of the origin of a received and displayed event message, e.g., with respect to row entry 220, the source of the event message is “alpha.hp.com.” Source column 202 includes an Internet Protocol (IP) address, or other address for designating the origination of the event message. Status column 204 is an indicator of whether a user has acknowledged the display of a particular event. For example, with respect to row entry 221, the particular event message has not been acknowledged; however, with respect to the same row entry 221 in FIG. 3, described in detail below, the event message has been acknowledged. In different embodiments, different status indicators may be used.

Severity column 204 is an indicator of the severity of the received event message. The severity may be determined by either the transmitting networked device, the desktop computer system 108, or a combination of both. Further, in another embodiment, a filter applied to received event messages filters the event messages displayed in user interface element 200. Row entries 220, 223, and 224 are indicated as minor severity while row entries 221 and 222 are indicated as information severity. In alternate embodiments, different severity indicators may be used.

Date column 208 is an indicator of the timestamp of occurrence of the event causing generation of the received event message. In another embodiment, date column 208 includes the timestamp of the receipt of the event message by desktop computer system 108. For example, row entry 220 has a date column 208 value of Oct. 22, 2004 11:10 am.

Description column 210 is an indicator of the contents of the received event message. For example, row entry 220 includes a description of the event stating that “Link active on port #5.”

As depicted in FIG. 2, a user has not acknowledged any received event messages, based on the content of status column 204. Further, none of the row entries 220-224 are selected.

In contrast with FIG. 2, FIG. 3 depicts the user interface element 200 (FIG. 2) after a user has selected two event messages, i.e., row entries 221 and 222. Solid line box 300 generally indicates the selection by a user of row entries 221 and 222. In different embodiments, selection of both row entries 221 and 222 by the user is indicated in a different manner, e.g., by changing the entry text style, by changing the entry background or foreground text color, or other similar display capabilities to distinguish selected row entries 221 and 222 from non-selected row entries 220, 223, and 224.

Further, FIG. 3 depicts the user interface element 200 after the user has acknowledged 3 of the 5 event messages, i.e., row entries 221, 222, and 223. Status column 204 values for row entries 221-223 unchanged from an asterisk to a hyphen (“-”) indicating the acknowledgement of the row entries. Acknowledgement of a row entry by a user indicates that the user has viewed the event message of the row entry and has performed an affirmative action to acknowledge awareness of the event message of the particular row entry.

Both selection of and acknowledgement of row entries involve the interaction of a user with items in the event list 200, i.e. user interface element 200. User interaction with event list 200 at the lowest level will not affect the selection of nor the acknowledgments status of individual row entries. That is, the acknowledgement status of an individual row entry is not changed by a user modifying the order in which the entries in the list 200 are sorted nor by the user modifying any applicable filter applied to determine the entries in the list. In order to change the acknowledgement status of a particular row entry, the user must select the particular row entry and provide an input commanding a change in the acknowledgement status.

Similarly, modification of the selection status of any particular row entry requires a user to interact with the individual entries of the list 200.

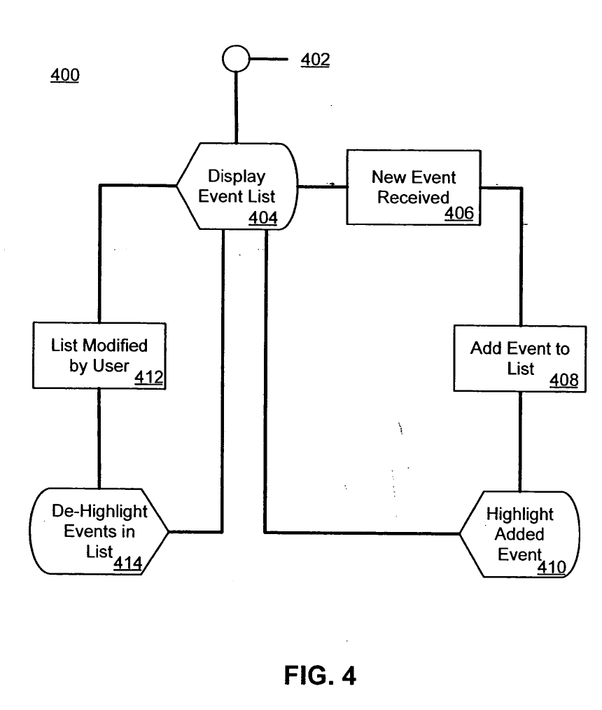

In accordance with an embodiment of the present invention, FIG. 4 depicts a high level process flow diagram of an embodiment wherein newly received event messages are added to event list 200 and displayed to the user in a manner arranged to remind the user at which point in the event list the newly received messages were received. That is, newly received messages are added to the event list 200 and distinguished, as a group, from previously received messages since the last time the user interacted with the events list.

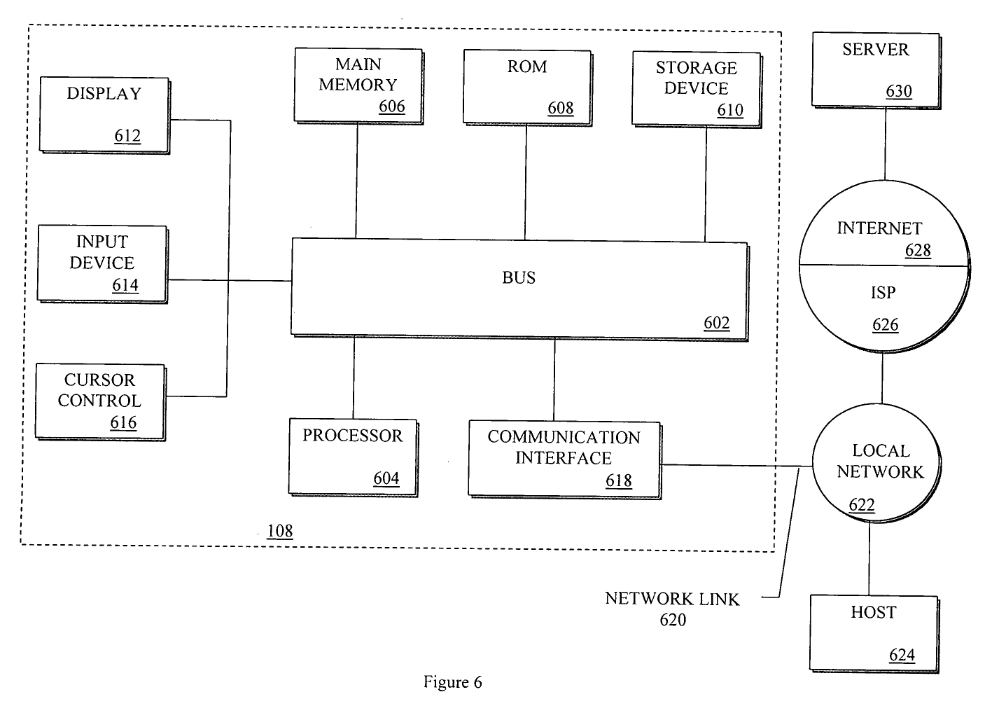

The process flow 400 depicted in FIG. 4 depicts a portion of a sequence of instructions executed by desktop computer system 108, for example. A processor 604 (described in detail below with reference to FIG. 6 below) reads the sequence of instructions from memory and executes the instructions causing desktop computer system 108 to drive display 612 to display user interface element 200 to user. That is, as processor 604 receives event messages from networked devices via communication interface 618, the processor drives display 612 to display event list 200 including the received event message contents and to apply a temporary visual indicator to event messages received at a time after the user has last interacted with the event list.

The flow of control begins at step 402 and proceeds to step 404 wherein the processor drives display 612 to display event list 200 to a user. As described above, upon receipt of a new event message from a networked device, the flow of control proceeds to step 406 wherein the new event is received. In one embodiment, the contents of the received event message are formatted and select information retrieved from the received event message. According to another embodiment, the select information retrieved corresponds to the information displayed in event list 200 columns.

After receipt of the event message, the flow of control proceeds to step 408 wherein the processor adds the event to the event list 200. The flow of control then proceeds to step 410 wherein a temporary visual indicator is applied to the newly added event. For example, the temporary visual indicator may be a highlighting, background and/or foreground color modification, text style, color, size, or other formatting of the event message in the event list. In particular, the temporary visual indicator is different than that applied to indicate selection of the event message in the event list by the user. The terms “temporary visual indicator” is intended to include a visual indicator different from the selected and non-selected visual indicators of an item. The visual indicator is temporary in that any user interaction with the list causes the removal of the temporary visual indicator applied from all items in the list.

The temporary visual indicator is used as an automatic bookmarking capability to remind the user of the new event messages received after the user last interacted with the event list 200. As long as the user does not interact with the event list (described more fully below), newly added event messages receive a temporary visual indicator applied to distinguish from previously existing messages prior to the last user interaction. Using this approach, the user is able to easily identify the most recently received messages.

After application of the temporary visual indicator to the event message, the flow of control proceeds to return to step 404 and display the event list including the newly received event message having the applied temporary visual indicator.

Returning to step 404, the event list 200 is displayed to the user. After receipt of a user interaction with the event list, the flow of control proceeds to step 412 wherein the user interaction is received and processed. User interaction with the event list includes user manipulation of individual row entries 220-224, e.g., selecting one or more row entries or issuing a command affecting one or more row entries such as an acknowledgement by manipulating an input device, or modification of the event list, e.g., modifying a filter applied to the event list or modifying sorting of the list. After receipt of the user interaction, the flow of control proceeds to step 414 wherein any temporary visual indicator applied to event messages in the event list 200 is removed from the event messages. The flow of control then returns to step 404 wherein the processor then drives display 612 to display event list 200 to the user without any temporary visual indicator applied to the event messages, e.g., the user interface element 200 as depicted in FIG. 2.

FIG. 5 depicts the event list 200 of FIG. 2 having a temporary visual indicator 500 applied to three most recently received event messages, i.e., row entries 220-222. In this manner, the user had previously viewed event list 200 and interacted with either the event list or the items of the list after receipt of the event message corresponding to row entry 223. After the last user interaction, the event messages corresponding to row entries 220-222 were received by desktop computer system 108 and the process flow described above with respect to FIG. 4 was executed by processor 604. After execution of the FIG. 4 flow, row entries 220-222 have a temporary visual indicator applied to distinguish them from row entries 223 and 224.

The visual indicator is temporary because as a result of the next user interaction with event list 200 or a row entry of the event list, the visual indicator is removed from all row entries in the list. In contrast with the selection 300 of FIG. 3, modification of a filter applied to event list 200, changing the sorting of the event list, or selecting an additional row entry in the event list will cause the removal of the temporary visual indicator from all row entries in the event list.

Further, the temporary visual indicator is applied to newly added row entries on receipt of a new event message without requiring user interaction. In contrast, any user interaction with the contents of the event list removes the temporary visual indicator. Scrolling of the event list is not user interaction with the event list as there is no modification of the event list properties or properties of the items in the event list.

Hardware Overview

FIG. 6 is a block diagram illustrating an exemplary computer system, e.g., desktop computer system 108 upon which an embodiment of the invention may be implemented. The present invention is usable with currently available personal computers, mini-mainframes, workstations, servers, and the like.

Computer system 108 includes a bus 602 or other communication mechanism for communicating information, and a processor 604 coupled with the bus 602 for processing information. Computer system 108 also includes a main memory 606, such as a random access memory (RAM) or other dynamic storage device, coupled to the bus 602 for storing transaction and interaction data, and instructions to be executed by processor 604. Main memory 606 also may be used for storing temporary variables or other intermediate information during execution of instructions to be executed by processor 604. Computer system 108 further includes a read only memory (ROM) 608 or other static storage device coupled to the bus 602 for storing static information and instructions for the processor 604. A storage device 610, such as a magnetic disk or optical disk, is provided and coupled to the bus 602 for storing transaction and interaction data, inventory data, orders data, and instructions.

Computer system 108 may be coupled via the bus 602 to a display 612, such as a cathode ray tube (CRT) or a flat panel display, for displaying an event list, i.e., user interface element 200, to a user. An input device 614, including alphanumeric and function keys, is coupled to the bus 602 for communicating information and command selections to the processor 604. Another type of user input device is cursor control 616, such as a mouse, a trackball, or cursor direction keys for communicating direction information and command selections to processor 604 and for controlling cursor movement on the display 612. This input device typically has two degrees of freedom in two axes, a first axis (e.g., x) and a second axis (e.g., y) allowing the device to specify positions in a plane.

The invention is related to the use of computer system 108, such as the illustrated system of FIG. 6, to distinguish more recently received items in an event list from previously received and viewed items in the event list. According to one embodiment of the invention, a temporary visual indicator is used to distinguish between items in the event list based on items received since the previous user interaction with the event list computer system 108 in response to processor 604 executing sequences of instructions contained in main memory 606 in response to input received via input device 614, cursor control 616, or communication interface 618. Such instructions may be read into main memory 606 from another computer-readable medium, such as storage device 610.

However, the computer-readable medium is not limited to devices such as storage device 610. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an electrically programmable read only memory (EPROM), a FLASH-EPROM, any other memory chip or cartridge, a carrier wave embodied in an electrical, electromagnetic, infrared, or optical signal, or any other medium from which a computer can read. Execution of the sequences of instructions contained in the main memory 606 causes the processor 604 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 108 also includes a communication interface 618 coupled to the bus 602. Communication interface 608 provides two-way data communication as is known. For example, communication interface 618 may be an integrated services digital network (ISDN) card, a digital subscriber line (DSL) card, a modem, or other similar device to provide a data communication connection to a corresponding type of telephone line. As another example, communication interface 618 may be a local area network (LAN) card to provide a data communication connection to a compatible LAN. Wireless links may also be implemented.

In any such implementation, communication interface 618 sends and receives electrical, electromagnetic or optical signals which carry digital data streams representing various types of information. Of particular note, the communications through interface 618 may permit transmission or receipt of event messages causing the update of the items displayed and temporarily visually indicated in the event list. Additionally, the event list may be generated at one networked device and displayed at another networked device For example, two or more computer systems 108 may be networked together in a conventional manner with each using the communication interface 618.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals which carry digital data streams. The signals through the various networks and the signals on network link 620 and through communication interface 618, which carry the digital data to and from computer system 108, are exemplary forms of carrier waves transporting the information.

Computer system 108 can send messages and receive data, including program code, through the network(s), network link 620 and communication interface 618. In the Internet example, a server 630 might transmit a requested code for an application program through Internet 628, ISP 626, local network 622 and communication interface 618. In accordance with the invention, one such downloaded application provides for applying a temporary visually indicator to items in a list.

The received code may be executed by processor 604 as it is received, and/or stored in storage device 610, or other non-volatile storage for later execution. In this manner, computer system 108 may obtain application code in the form of a carrier wave.

In one embodiment, a temporary visual indicator is applied to items added to a list displayed to a user. For example, an event list 200 on desktop computer system 108 is configured to display a list of items transmitted from the desktop computer system to a networked device. As items are added to the event list 200, a temporary visual indicator is applied to the items added subsequent to the last user interaction with the list. The temporary visual indicator is removed from items in the event list 200 subsequent to a user interaction with the list.

In another embodiment, a temporary visual indicator is applied to items added to a list displayed to a user where the list of items includes events local to the desktop computer system 108, e.g., software executable events such as operating system or application-level events.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method for temporary visual indication of added items in a list, comprising the steps of:
receiving an item to be presented in a list to be displayed to a user;
adding the item to the list to be displayed to the user;
applying a temporary visual indicator to the received item in the list; and
removing the temporary visual indicator from each item in the list having a visual indicator applied, in response to user interaction with the list.

2. The method of claim 1, further comprising the steps of:
receiving an other item to be presented in the list; and
applying the temporary visual indicator to the received other item in the list,
wherein the receiving an other item step and the applying the temporary visual indicator to the received other item step are performed prior to user interaction with the list.

3. The method of claim 2, the applied temporary visual indicator of the received other item being the same as the temporary visual indicator of the received item in the list.

4. The method of claim 1, the temporary visual indicator is highlighting.

5. The method of claim 1, the temporary visual indicator is a color attribute.

6. The method of claim 1, the temporary visual indicator is a text attribute.

7. The method of claim 1, wherein user interaction is solely with the list.

8. The method of claim 1, the temporary visual indicator is removed in response to a first user input affecting the list.

9. The method of claim 1, user interaction with the list is selecting an item in the list.

10. The method of claim 1, user interaction with the list is modifying a list attribute.

11. The method of claim 10, modifying a list attribute is filtering the item in the list.

12. The method of claim 10, modifying a list attribute is sorting the list.

13. The method of claim 1, the received item is an event.

14. The method of claim 13, the event is a network event.

15. A system of visually indicating items in a list, comprising:
a processor;
a memory having instructions causing the processor to: drive a display to display an item in a list responsive to receiving an item to be displayed to a user; apply a visual indicator to the received item to be displayed in the list; and remove the visual indicator from the received item to be displayed in the list responsive to user interaction with the list.

16. The system of claim 15, the memory further comprising instructions causing the processor to: (a) receive an other item to be displayed in the list; and (b) apply the visual indicator to the other item displayed in the list, wherein the steps (a) and (b) are performed prior to user interaction with the displayed list.

17. The system of claim 15, the temporary visual indicator is at least one of highlighting, a color attribute, and a text attribute of the item in the list.

18. The system of claim 15, the memory further comprising instructions causing the processor to remove the temporary visual indicator from all items having the temporary visual indicator applied in response to a first user input affecting the list.

19. The system of claim 15, the user interaction with the list is at least one of selecting an item in the list and modifying a list attribute.

20. The system of claim 15, further comprising:
a communication interface operatively connected with the processor, and
wherein the received item is an event message received via the communication interface.
